(19) United States
(12) Patent Application Publication
(10) Pub. No.: US 2013/0205051 A1
(43) Pub. Date: Aug. 8, 2013

(54) Methods and Devices for Buffer Allocation

(71) Applicants: Feng Wang, San Diego, CA (US); Jonghae Kim, (US)

(72) Inventors: Feng Wang, San Diego, CA (US); Jonghae Kim, (US)

(73) Assignee: QUALCOMM INCORPORATED, San Diego, CA (US)

(21) Appl. No.: 13/474,144

(22) Filed: May 17, 2012

Related U.S. Application Data
(60) Provisional application No. 61/595,784, filed on Feb. 7, 2012.

(51) Int. Cl. G06F 3/00

(52) U.S. Cl. 710/56

(57) ABSTRACT

Methods and devices for buffer allocation based on priority levels are disclosed to avoid or mitigate conflicts that can degrade performance or otherwise interfere with Quality of Service (QoS) requirements in a multiple channel memory system. In one embodiment, the methods and devices disclosed herein may be used to detect various transactions that have identical priorities and the same or similar QoS requirements and then allocate buffers for different ones of the various detected transactions that are scheduled to occur in a given time interval to different independent memory channels, thereby avoiding or mitigating memory access conflicts in the given time interval.

### CLAIM OF PRIORITY UNDER 35 U.S.C. §119

The present application claims priority to U.S. Provisional Patent Application Ser. No. 61/595,781, entitled “METHODS AND DEVICES FOR BUFFER ALLOCATION,” filed Feb. 7, 2012, assigned to the assignee hereof, the contents of which are hereby incorporated by reference in their entirety.

### FIELD OF DISCLOSURE

The present disclosure generally relates to buffer allocation in multiple channel memory systems, and more particularly, to allocating buffers to memory channels based on Quality of Service (QoS) requirements to achieve optimal system performance.

### BACKGROUND

Conflicts and non-optimal buffer allocation can occur in systems that use multiple master devices and multiple channel memory. For example, although buffer allocation in conventional multiple channel memory systems may consider memory footprint requirements and available bandwidth associated with memory channels to meet various software constraints, conventional multiple channel memory systems often ignore Quality of Service (QoS) requirements intended to achieve optimal system performance.

It would therefore be desirable to improve buffer allocation in multiple channel memory systems in a manner that may address the above-mentioned shortcomings associated with conventional systems that often ignore QoS requirements when allocating buffers.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any aspect. Its sole purpose is to present some concepts of one or more aspects in a simplified form as a prelude to the more detailed description that is presented below.

Exemplary embodiments provide various mechanisms to control buffer allocation in multiple channel memory systems, wherein the buffer allocation mechanisms may consider memory footprint requirements and available bandwidth associated with multiple memory channels in addition to one or more software constraints and one or more QoS requirements. As such, in a system with one or more QoS requirements, buffers for transactions associated with one or more master devices may be allocated to independent memory channels to improve the effectiveness associated with the QoS requirements and thereby achieve optimal system performance. For example, in one embodiment, allocating the buffers for the transactions to independent memory channels may distribute the transactions among the multiple different memory channels in the system and therefore achieve a temporal load balance in each independent memory channel based on priority profiles associated with the transactions (e.g., buffers for overlapping transactions from different master devices that have the same priority level, latency requirement, or other QoS requirements may be allocated to different independent memory channels to prevent or mitigate the overlapping transactions from having to compete for available bandwidth). Accordingly, the exemplary embodiments disclosed herein to control buffer allocation in multiple channel memory systems may consider QoS requirements in addition to various other factors to improve latency, throughput, or other performance criteria.

According to one embodiment, a method for buffer allocation in a multiple channel memory system may comprise, among other things, detecting a plurality of high priority transactions that have a low latency requirement, determining two or more of the plurality of high priority transactions that occur in a given time interval, and allocating buffers for the two or more high priority transactions to different independent memory channels. As such, allocating the buffers for the two or more high priority transactions to the respective independent memory channels may avoid memory access conflicts in the given time interval and ensure that the two or more high priority transactions satisfy the low latency requirement, which may include one or more QoS requirements, minimum bandwidth requirements, software constraints, or other performance criteria. Furthermore, in one embodiment, the plurality of high priority transactions may be associated with various different master devices, in which case the method may further comprise allocating the buffers for any of the high priority transactions that are associated with the same master device to the same independent memory channel and further allocating buffers for a set of the high priority transactions that are non-overlapping and associated with different master devices to the same independent memory channel. In this manner, the method for buffer allocation may avoid transactions associated with the same master device occupying different independent memory channels, thereby enabling buffers for transactions from other master devices to be allocated to other independent memory channels, and moreover, the non-overlapping transactions may satisfy associated priority profiles and QoS requirements without interfering with the buffer allocation associated with the other transactions in the given time interval.

According to another embodiment, the method for buffer allocation in the multiple channel memory system may further comprise detecting one or more medium priority transactions and/or low priority transactions that occur in the given time interval and distributing buffers allocated for the one or more medium priority transactions and/or low priority transactions among the various independent memory channels to avoid or mitigate interference with the two or more high priority transactions in the given time interval.

According to another embodiment, a method for buffer allocation in a multiple channel memory system may comprise, among other things, detecting a plurality of transactions that have an identical priority and one or more of a throughput or latency requirement in given time interval, wherein the detected plurality of transactions that have the identical priority are scheduled to occur in a given time interval, and allocating buffers for the detected plurality of transactions to different independent memory channels. As such, allocating the buffers for the plurality of transactions having the identical priority to the respective independent memory channels may avoid memory access conflicts in the given time interval and ensure that the detected plurality of transactions satisfy the throughput or latency requirement associated therewith, which may include a QoS requirement, a software constraint, or other performance criteria.

According to another embodiment, an apparatus for buffer allocation in a multiple channel memory system may comprise a multiple channel memory architecture that includes multiple independent memory channels and one or more processors configured to detect a plurality of high priority transactions that have a low latency requirement (e.g., a QoS requirement, a minimum bandwidth requirement, etc.), determine two or more of the plurality of high priority transactions that occur in a given time interval, and allocate buffers for the two or more high priority transactions to different ones of the multiple independent memory channels to avoid memory access conflicts in the given time interval. In one embodiment, the plurality of high priority transactions may be associated with a plurality of master devices, wherein the buffers for the high priority transactions associated with each of the plurality of master devices may be allocated to the same independent memory channel, while buffers for a set of the high priority transactions that are non-overlapping and associated with different master devices may be further allocated to the same independent memory channel.

According to another embodiment, the one or more processors associated with the apparatus for buffer allocation in the multiple channel memory system may be further configured to detect one or more medium priority transactions and/or low priority transactions that occur in the given time interval and distribute buffers allocated for the one or more medium priority transactions and/or low priority transactions among the various independent memory channels to avoid or mitigate interference with the high priority transactions in the given time interval.

According to another embodiment, an apparatus for buffer allocation in a multiple channel memory system may comprise means for detecting a plurality of high priority transactions having a low latency requirement (e.g., a QoS requirement, a minimum bandwidth requirement, etc.), means for determining two or more of the plurality of high priority transactions that occur in a given time interval, and means for allocating buffers for the two or more high priority transactions to different independent memory channels to avoid memory access conflicts in the given time interval. In one embodiment, the plurality of high priority transactions may be associated with a plurality of master devices, wherein the buffers for the high priority transactions associated with each of the plurality of master devices may be allocated to the same independent memory channel, while buffers for a set of the high priority transactions that are non-overlapping and associated with different master devices may be further allocated to the same independent memory channel.

According to another embodiment, the apparatus for buffer allocation in the multiple channel memory system may further comprise means for detecting one or more medium priority transactions and/or low priority transactions that occur in the given time interval and means for distributing buffers allocated for the one or more medium priority transactions and/or low priority transactions among the various independent memory channels to balance bandwidth across the various independent memory channels without interfering with the buffer allocation associated with the high priority transactions in the given time interval.

According to another embodiment, a computer-readable medium may store computer-executable instructions for buffer allocation in a multiple memory channel system, wherein executing the computer-executable instructions on a processor may cause the processor to detect a plurality of high priority transactions having a low latency requirement (e.g., a QoS requirement, a minimum bandwidth requirement, etc.), determine two or more of the plurality of high priority transactions that occur in a given time interval, and allocate buffers for the two or more high priority transactions to different independent memory channels to avoid memory access conflicts in the given time interval. In one embodiment, the plurality of high priority transactions may be associated with a plurality of master devices, wherein the buffers for the high priority transactions associated with each of the plurality of master devices may be allocated to the same independent memory channel. Furthermore, in one embodiment, executing the computer-executable instructions on the processor may further cause the processor to determine a set of the high priority transactions that occur in the given time interval which are non-overlapping and associated with different ones of the plurality of master devices and allocate buffers for the set of non-overlapping high priority transactions to the same independent memory channel.

According to another embodiment, the computer-readable medium may further store computer-executable instructions, which when executed on the processor, may further cause the processor to detect one or more medium priority transactions and/or low priority transactions and distribute buffers allocated for the one or more medium priority transactions and/or low priority transactions among the various independent memory channels to avoid or mitigate interference with the high priority transactions in the given time interval.

Other objects and advantages associated with the embodiments disclosed herein to control buffer allocation in multiple channel memory systems will be apparent to those skilled in the art based on the accompanying drawings and detailed description.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates an exemplary interconnection associated with various components in an exemplary multiple channel memory architecture, according to one exemplary embodiment.

FIG. 2 illustrates another exemplary interconnection in a multiple channel memory architecture in addition to an exemplary buffer allocation for transactions associated with various master devices, according to one exemplary embodiment.

FIG. 3 illustrates an exemplary buffer allocation associated with data buffered from various master devices, according to one exemplary embodiment.

FIG. 4 illustrates another exemplary buffer allocation associated with data buffered from various master devices having overlapping high priority transactions, according to one exemplary embodiment.

FIG. 5 illustrates an exemplary method for buffer allocation in a multiple channel memory system, according to one exemplary embodiment.

FIG. 6 illustrates an exemplary communication system that may employ the buffer allocation techniques described herein, according to one exemplary embodiment.

### DETAILED DESCRIPTION

Aspects of the invention are disclosed in the following description and related drawings showing specific examples having various exemplary embodiments of the invention. Alternate embodiments may be apparent those skilled in the pertinent art upon reading this disclosure, and may be constructed and practiced without departing from the scope or spirit of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The term “buffer” can mean a storage element, register or the like or can represent a structure that is implemented by way of instructions that operate on a processor, controller or the like.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope or spirit of the claimed subject matter. In addition, for each of the embodiments described herein, the corresponding form of any such embodiments may be described herein as, for example, “logic configured to” perform the described action.

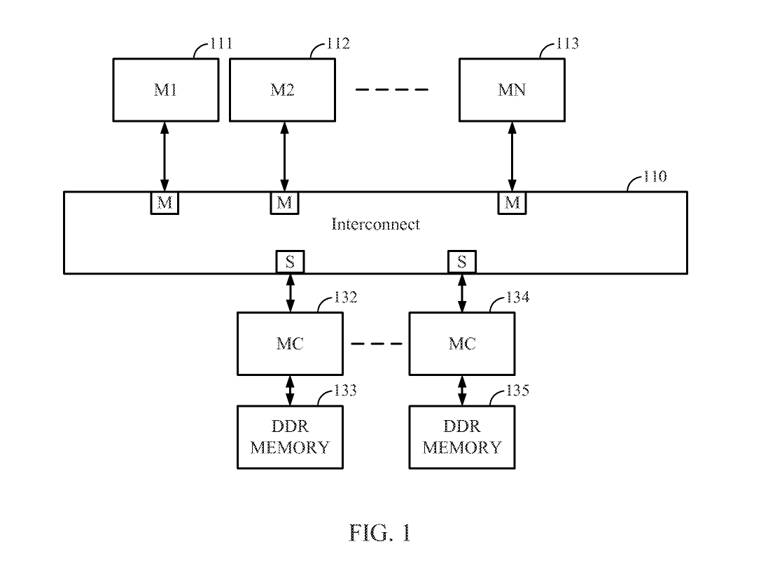

According to one exemplary embodiment, FIG. 1 illustrates an exemplary interconnection associated with various components in an exemplary multiple channel memory architecture. In one embodiment, the multiple channel memory architecture shown in FIG. 1 may include a first set of master devices, for example master devices M1, M2, . . . MN respectively labeled in FIG. 1 as items 111, 112, and 113, may be connected to a bus or other suitable interconnect (e.g., interconnect 110). In one embodiment, one or more slave devices, including memory controller devices (e.g., MC 132 and MC 134) and double data rate (DDR) memory devices (e.g., DDR memory 133 and DDR Memory 135) may be further coupled to Interconnect 110. This connection allows for access requests or other traffic from master devices M1 111, M2 112, and MN 113 to slave devices MC 132, DDR memory 133, MC 134, and DDR Memory 135 through Interconnect 110. It will be appreciated that a larger number of access requests can be made, for example, from master devices M1 111, M2 112, and MN 113 to slave devices MC 132, DDR memory 133, MC 134, and DDR Memory 135, which could cause poor performance or non-compliance with QoS requirements without proper memory management mechanisms.

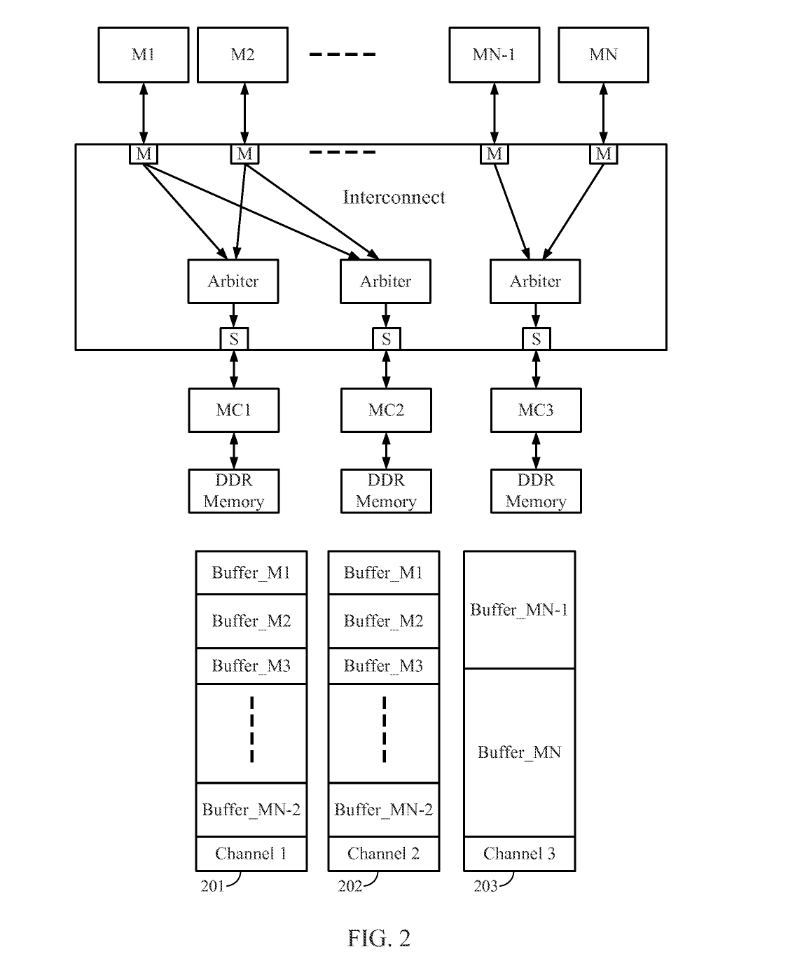

According to another exemplary embodiment, FIG. 2 illustrates an exemplary interconnection similar to that shown in FIG. 1 and described above in addition to an exemplary buffer allocation for transactions associated with various master devices, for example master devices M1, M2 . . . MN, which may be connected to a bus or another suitable interconnect. Slave devices, including one or more memory controllers (e.g., MC1, MC2, MC3) and DDR memory devices can be operatively coupled to the master devices through the interconnect. Further, the multiple channel memory architecture shown in FIG. 2 may include one or more arbiters to coordinate memory access requests that the master devices communicate to the slave devices via the interconnect.

FIG. 2 includes representative illustrations of buffers for different independent memory channels 201, 202, and 203. In this example, buffers storing transaction data associated with access requests from various master devices (e.g., Buffer_M1, Buffer_M2, etc.) may be distributed across the various independent memory channels 201, 202, and 203, wherein the buffers may be coupled to the slave devices (e.g., MC1, MC2, MC3, and the associated DDR Memories) to buffer the transaction data associated with the access requests. As shown in FIG. 2, each buffer may queue one or more access requests, which may cause further processing of access requests to back up, reduce throughput, increase latency, or otherwise fail to comply with QoS requirements.

To address the foregoing, buffer allocation mechanisms may be designed to consider system latency requirements, minimum bandwidth requirements, or other QoS requirements in addition to various other factors associated with the access requests from the various master devices. For example, in a system with one or more QoS requirements, buffers for the transaction data associated with the access requests from the various master devices can be allocated to independent memory channels to ensure compliance with QoS requirements and achieve improved system performance. For example, the process of allocating the buffers to independent memory channels may distribute the transaction data across the various independent memory channels and thereby achieve a temporal load balance based on a priority profile associated with the access requests. In one example, where there are one or more access requests from different master devices with the same priority level, the access requests from the different master devices may be allocated respective buffers in different independent memory channels, as the multiple channel memory architecture permits.

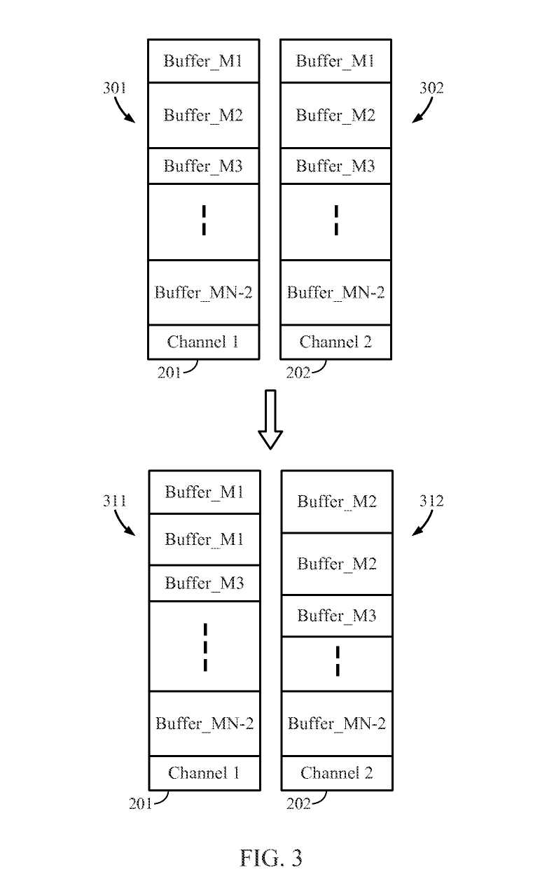

According to one exemplary embodiment, FIG. 3 illustrates an exemplary buffer allocation associated with data buffered from various master devices. As shown in FIG. 3, master devices M1 and M2 have the most stringent latency requirements and are assigned a highest priority. If these QoS requirements were not considered, access requests (e.g., read commands, write commands, and associated data) from master devices M1 and M2 may be allocated to memory channel 201 and memory channel 202, as illustrated in buffer allocations 301 and 302, for example. Accordingly, despite having the highest priority, the access requests from master devices M1 and M2 would have to compete for available bandwidth or tokens in buffer allocations 301 and 302 that do not consider the QoS requirements associated therewith. Consequently, the access requests from master device M1 and/or master device M2 could stall the access requests associated with transactions from the other master device even though both may have the same (i.e., highest) priority. In contrast, the exemplary buffer allocation illustrated at 311 and 312 may consider the QoS requirements associated with master devices M1 and M2, whereby the access requests associated with master devices M1 and M2 may be assigned to different memory channels 201 and 202. For example, in the illustrated embodiment, the access requests associated with master device M1 are assigned to memory channel 201 and the access requests associated with master device M2 are assigned to memory channel 202. Additionally, access requests associated with master device M3 are distributed across memory channels 201 and 202, but in this example the access requests associated with master device M3 have a lower priority (e.g., a medium or low priority), and therefore the access requests associated with master device M3 will not interfere with the QoS requirements associated with the access requests from master devices M1 and M2.

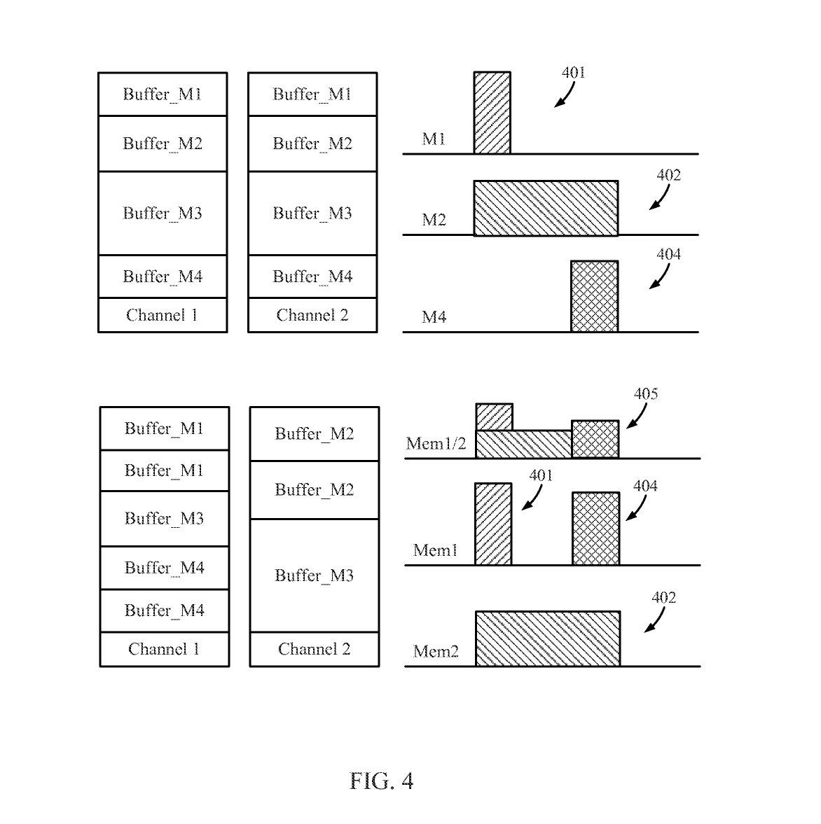

According to one exemplary embodiment. FIG. 4 illustrates another exemplary buffer allocation associated with data buffered from various master devices having overlapping high priority transactions. In the illustrated embodiment, master device M1 may be assumed to have 1000 transactions per millisecond at priority level 1, master device M2 may be assumed to have 4000 transactions per millisecond at priority level 1, master device M3 may be assumed to have 5000 transactions per millisecond at priority level 2, and master device M4 may be assumed to have 1000 transactions per millisecond at priority level 1. Additionally, as illustrated, the unallocated access requests from the various master devices (e.g., access request 401 for master device M1, access request 402 for master device M2, and access request 404 for master device M4) may occur at different times in a memory access cycle. However, a buffer allocation combining the access requests over two memory channels (e.g., Mem1/2) could result in one or more of the access requests at priority level 1 being delayed, as graphically illustrated at 405. To avoid this problem, a buffer allocation or reallocation in accordance with the exemplary embodiments disclosed herein may consider the timing associated with the memory access cycle in addition to bandwidth requirements and the priority levels associated with the access requests relating to the transactions from the various master devices M1, M2, and M4 to avoid potential disruptions or non-compliance with the QoS requirements. For example, as illustrated, the access requests associated with the transactions 401 and 404 from master devices M1 and M4 can be allocated to memory channel 1 (Mem1) and the access requests associated with the transactions 402 from master devices M2 can be allocated to memory channel 2 (Mem2). Furthermore, the access requests associated with the transactions 402 from master devices M3, which have a lower priority than the access requests 401, 402, and 404 from master devices M1, M2, and M4, can be allocated to or distributed across either or both memory channels and interleaved with the high priority transactions 401, 402, and 404 to balance bandwidth across both memory channels and avoid negatively impacting the QoS requirements associated with the high priority transactions 401, 402, and 404 from master devices M1, M2 and M4.

It will be appreciated that the foregoing illustrations are exemplary only and that one or more embodiments may have more or less independent memory channels, master devices, slave devices, memory controllers, interconnects, and additional hardware and/or software components. Therefore, the foregoing illustrations and any description contained herein will be understood to not limit the various embodiments to a specific architecture, arrangement, or number of components.

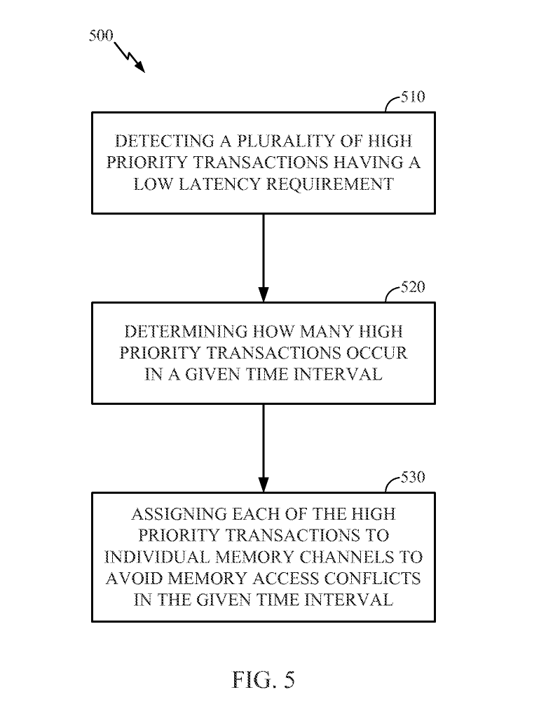

According to one exemplary embodiment, FIG. 5 illustrates an exemplary method 500 for buffer allocation in a multiple channel memory system. In view of the foregoing, those skilled in the pertinent art will appreciate that the various sequences of actions, algorithms, operations, and/or processes described herein may be implemented in one or more methods according to various embodiments. Accordingly, the exemplary method 500 for buffer allocation in the multiple channel memory system can include sequences as illustrated in FIG. 5. For example, an operation 510 may include detecting a plurality of transactions having a low latency requirement. A determination can be made to identify one or more of the high priority transactions occur in a given time interval in an operation 520. Then, in an operation 530, buffers for each of the identified high priority transactions that occur in the given time interval can be allocated to different independent memory channels to avoid memory access conflicts in the given time interval and ensure that the identified high priority transactions satisfy their respective low latency requirements. It will be appreciated that the low latency requirement can be a QoS requirement, a minimum bandwidth requirement, a software constraint, or any other suitable performance criteria.

Further, as illustrated in the foregoing, the plurality of high priority transactions can be associated with a plurality of different master devices, in which case the buffers allocated for the transactions from a particular one of the master devices can be allocated to the same independent memory channel. Likewise, if any of the high priority transactions are non-overlapping in the given time interval and associated with different master devices, (e.g., as illustrated in FIG. 4 and described above), the buffers for the non-overlapping high priority transactions can be allocated to the same independent memory channel (e.g., as shown in FIG. 4 at 401 and 404, where buffers associated with high priority transactions from different master devices are allocated to the same independent memory channel Mem1). In this manner, the method 500 for buffer allocation may avoid transactions associated with the same master device occupying different independent memory channels, thereby enabling buffers for transactions from other master devices to be allocated to other independent memory channels, and moreover, the non-overlapping transactions may satisfy associated priority profiles and QoS requirements without interfering with the buffer allocation associated with the other transactions in the given time interval.

Further, those skilled in the pertinent art will appreciate that the various sequences of actions, algorithms, operations, and/or processes may be implemented or otherwise embodied in various configurations, including various different combinations of hardware components and/or software components executed on the hardware components. Accordingly, one embodiment can include an apparatus configured to allocate buffer usage in a multiple channel memory system having a plurality of buffers and multiple independent memory channels. The apparatus can further include one or more processors configured to detect a plurality of high priority transactions that have a low latency requirement (e.g., a QoS requirement, a minimum bandwidth requirement, etc.), determine how many of the plurality of high priority transactions occur in a given time interval, and allocate buffers for the high priority transactions that occur in the given time interval to different ones of the multiple independent memory channels to avoid memory access conflicts in the given time interval. In one embodiment, the one or more processors configured to perform these various actions, algorithms, operations, and/or processors may comprise one or more independent elements or one or more elements incorporated either in whole or in part into one or more existing elements associated with a multiple channel memory system (e.g., an interconnect, a memory controller, an arbiter, DDR memory, etc.).

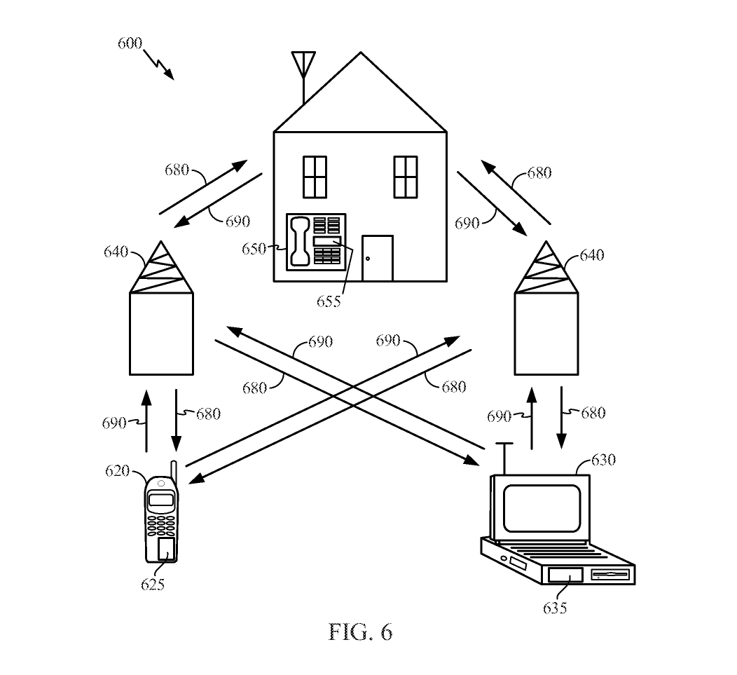

According to one exemplary embodiment, FIG. 6 illustrates an exemplary wireless communication system 600 that may employ the exemplary buffer allocation techniques described herein. For purposes of illustration, FIG. 6 shows three remote units 620, 630, and 650 and two base stations 640. Those skilled in the pertinent art will recognize that other wireless communication systems in accordance with the exemplary embodiments described herein may have more or fewer remote units and/or base stations without departing from the scope or spirit of the exemplary embodiments described herein. In one embodiment, the remote units 620, 630, and 650 may include respective semiconductor devices 625, 635, and 655, wherein the remote units 620, 630, and 650 and/or the semiconductor devices 625, 635, and 655 respectively associated therewith may include devices in which the buffer allocation methods described herein may be implemented. In one embodiment, as shown in FIG. 6, one or more forward link signals 680 may be used to communicate data from the base stations 640 to the remote units 620, 630, and 650 and one or more reverse link signals 690 may be used to communicate data from the remote units 620, 630, and 650 to the base stations 640.

In the exemplary embodiment shown in FIG. 6, the remote unit 620 may comprise a mobile telephone, the remote unit 630 may comprise a portable computer, and the remote unit 650 may comprise a fixed-location remote unit in a wireless local loop system (e.g., meter reading equipment). In various embodiments, however, the remote units 620, 630, and 650 may include mobile phones, handheld personal communication systems units, portable data units, personal data assistants, navigation devices (e.g., GPS-enabled or location-aware devices), set-top boxes, music players, video players, entertainment units, fixed-location data units, or any other device or combination of devices that can suitably store, retrieve, communicate, or otherwise process data and/or computer-executable instructions. Although FIG. 6 illustrates remote units 620, 630, and 650 according to the teachings of the disclosure, those skilled in the pertinent art will appreciate that the disclosure shall not be limited to these exemplary illustrated remote units 620, 630, and 650. Accordingly, various embodiments may be suitably employed or otherwise implemented in any suitable device that has active integrated circuitry including memory and on-chip circuitry for test and characterization.

Those skilled in the pertinent art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields, particles, or any combination thereof.

Further, those skilled in the pertinent art will appreciate that the various illustrative logical blocks, modules, circuits, algorithms, and steps described in connection with the embodiments disclosed herein may be implemented as electronic hardware, computer software, or any suitable combinations thereof. To clearly illustrate this interchangeability of hardware and software, various illustrative components, blocks, modules, circuits, algorithms, and steps have been described above in terms of their general functionality. Whether such functionality is implemented in hardware or software depends upon the particular application and design constraints, and those skilled in the pertinent art may implement the described functionality in various ways to suit each particular application, but such implementation decisions should not be interpreted as causing a departure from the scope or spirit of the present invention.

The methods, sequences and/or algorithms described in connection with the embodiments disclosed herein may be embodied directly in hardware, in a software module executed by a processor, or any suitable combination thereof. Software modules may reside in memory controllers, DDR memory, RAM memory, flash memory, ROM memory, EPROM memory, EEPROM memory, registers, hard disks, removable disks. CD-ROMs, or any other known or future-developed storage medium. An exemplary storage medium is coupled to the processor such that the processor can read information from, and write information to, the storage medium. In the alternative, the storage medium may be integral to the processor.

Accordingly, an embodiment of the invention can include a computer-readable medium embodying computer-executable instructions to perform a method for buffer allocation in a multiple channel memory system. Accordingly, the invention is not limited to illustrated examples and any means for performing the functionality described herein are included in embodiments of the invention.

The foregoing disclosed methods are typically designed and are configured into GDSII and GERBER computer files, stored on a computer-readable medium. These computer files are in turn provided to fabrication handlers who fabricate devices based on these files. The resulting products are semiconductor wafers that may then be cut into semiconductor die and packaged into a semiconductor chip. The chips are then employed in the devices described above.

While the foregoing disclosure shows illustrative embodiments of the invention, those skilled in the pertinent art will appreciate that various changes and modifications could be made herein without departing from the scope or spirit of the invention, as defined by the appended claims. The functions, steps, operations, and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for buffer allocation in a multiple channel memory system, the method comprising:
detecting a plurality of high priority transactions, wherein the plurality of high priority transactions have a low latency requirement;
determining two or more of the plurality of high priority transactions that occur in a given time interval; and
allocating buffers for the two or more high priority transactions to two or more independent memory channels to avoid memory access conflicts in the given time interval.

2. The method of claim 1, wherein the low latency requirement comprises a Quality of Service requirement.

3. The method of claim 1, wherein the low latency requirement comprises a minimum bandwidth requirement.

4. The method of claim 1, further comprising:
detecting one or more lower priority transactions that occur in the given time interval, wherein the one or more lower priority transactions have one or more of a medium priority or a low priority; and
distributing buffers allocated for the one or more lower priority transactions among the two or more independent memory channels without interfering with the buffer allocation associated with the two or more high priority transactions.

5. The method of claim 1, wherein the plurality of high priority transactions are associated with a plurality of master devices.

6. The method of claim 5, wherein the buffers for the high priority transactions associated with each of the plurality of master devices are allocated to the same one of the two or more independent memory channels.

7. The method of claim 5, further comprising:
determining a set of the two or more high priority transactions that are non-overlapping in the given time interval and associated with different ones of the plurality of master devices; and
allocating the buffers for the set of non-overlapping high priority transactions to the same one of the two or more independent memory channels.

8. An apparatus for buffer allocation, comprising:
a multiple channel memory architecture, wherein the multiple channel memory architecture includes multiple independent memory channels; and
one or more processors configured to detect a plurality of high priority transactions that have a low latency requirement, determine two or more of the plurality of high priority transactions that occur in a given time interval, and allocate buffers for the two or more high priority transactions to two or more of the multiple independent memory channels to avoid memory access conflicts in the given time interval.

9. The apparatus of claim 8, wherein the low latency requirement comprises one or more of a Quality of Service requirement or a minimum bandwidth requirement.

10. The apparatus of claim 8, wherein the one or more processors are further configured to:
detect one or more lower priority transactions that occur in the given time interval, wherein the one or more lower priority transactions have one or more of a medium priority or a low priority; and
distribute buffers allocated for the one or more lower priority transactions among the two or more independent memory channels without interfering with the buffer allocation associated with the two or more high priority transactions.

11. The apparatus of claim 8, wherein the plurality of high priority transactions are associated with a plurality of master devices.

12. The apparatus of claim 11, wherein the buffers for the high priority transactions associated with each of the plurality of master devices are allocated to the same one of the two or more independent memory channels.

13. The apparatus of claim 11, wherein the one or more processors are further configured to:
determine a set of the two or more high priority transactions that are non-overlapping in the given time interval and associated with different ones of the plurality of master devices; and
allocate the buffers for the set of non-overlapping high priority transactions to the same one of the two or more independent memory channels.

14. An apparatus for buffer allocation in a multiple channel memory system, comprising:
means for detecting a plurality of high priority transactions, wherein the plurality of high priority transactions have a low latency requirement;
means for determining two or more of the plurality of high priority transactions that occur in a given time interval; and
means for allocating buffers for the two or more high priority transactions to two or more independent memory channels to avoid memory access conflicts in the given time interval.

15. The apparatus of claim 14, wherein the low latency requirement comprises one or more of a Quality of Service requirement or a minimum bandwidth requirement.

16. The apparatus of claim 14, further comprising:
means for detecting one or more lower priority transactions that occur in the given time interval, wherein the one or more lower priority transactions have one or more of a medium priority or a low priority; and
means for distributing buffers allocated for the one or more lower priority transactions among the two or more independent memory channels without interfering with the buffer allocation associated with the two or more high priority transactions.

17. The apparatus of claim 14, wherein the plurality of high priority transactions are associated with a plurality of master devices and the buffers for the high priority transactions associated with each of the plurality of master devices are allocated to the same one of the two or more independent memory channels.

18. The apparatus of claim 17, further comprising:
means for determining a set of the two or more high priority transactions that are non-overlapping in the given time interval and associated with different ones of the plurality of master devices; and
means for allocating the buffers for the set of non-overlapping high priority transactions to the same one of the two or more independent memory channels.

19. A computer-readable medium storing computer-executable instructions for buffer allocation in a multiple memory channel system, wherein executing the computer-executable instructions on a processor causes the processor to:
detect a plurality of high priority transactions, wherein the plurality of high priority transactions have a low latency requirement;
determine two or more of the plurality of high priority transactions that occur in a given time interval; and
allocate buffers for the two or more high priority transactions to two or more independent memory channels to avoid memory access conflicts in the given time interval.

20. The computer-readable medium of claim 19, wherein the low latency requirement comprises one or more of a Quality of Service requirement or a minimum bandwidth requirement.

21. The computer-readable medium of claim 19, wherein executing the computer-executable instructions on the processor further causes the processor to:
detect one or more lower priority transactions that occur in the given time interval, wherein the one or more lower priority transactions have one or more of a medium priority or a low priority; and
distribute buffers allocated for the one or more lower priority transactions among the two or more independent memory channels without interfering with the buffer allocation associated with the two or more high priority transactions.

22. The computer-readable medium of claim 19, wherein the plurality of high priority transactions are associated with a plurality of master devices and the buffers for the high priority transactions associated with each of the plurality of master devices are allocated to the same one of the two or more independent memory channels.

23. The computer-readable medium of claim 22, wherein executing the computer-executable instructions on the processor further causes the processor to:
determine a set of the two or more high priority transactions that are non-overlapping in the given time interval and associated with different ones of the plurality of master devices; and
allocate the buffers for the set of non-overlapping high priority transactions to the same one of the two or more independent memory channels.

24. A method for buffer allocation in a multiple channel memory system, the method comprising:
detecting a plurality of transactions scheduled to occur in a given time interval, wherein the detected plurality of transactions have an identical priority and one or more of a throughput requirement or a latency requirement; and
allocating buffers for the detected plurality of transactions having the identical priority to different independent memory channels in the given time interval.
